(19) United States
(12) Patent Application Publication
(10) Pub. No.: US 2013/0275577 A1
(43) Pub. Date: Oct. 17, 2013

(54) Selecting Content Within a Web Page

(71) Applicant: Suk Hwan Lim, Mountain View, CA (US)

(72) Inventor: Suk Hwan Lim, Mountain View, CA (US)

(21) Appl. No.: 13/817,741

(22) PCT Filed: Dec. 14, 2010
(86) PCT No.: PCT/US10/60336

§ 371 Date: Feb. 19, 2013

(51) Int. Cl. H04L 12/26

(52) U.S. Cl. CPC H04L 43/06
USPC 709/224

(57) ABSTRACT

A method of selecting content within a web page (FIG. 1, 110; FIG. 2C, 207; FIG. 4, 407; FIG. 5, 507) comprising: accessing first web page data associated with at least one previously accessed web page, the first web page data describing popular content within the previously accessed web page previously selected by a group of users, accessing second web page data associated with a currently accessed web page (FIG. 1, 110; FIG. 2C, 207; FIG. 4, 407; FIG. 5, 507), comparing the first web page data with the second web page data, and presenting to a user, via an output device (FIG. 1, 150), equivalent web page data selected most often within the at least one previously accessed web page as selected content within the currently accessed web page (FIG. 1, 110; FIG. 2C, 207; FIG. 4, 407; FIG. 5, 507).

### BACKGROUND

The Internet is providing many users throughout the world with the ability to access large amounts and varieties of information at previously unthinkable speeds. Indeed, with the advent of the Internet other means of communication such as newspapers, telephones, and mail are becoming obsolete and consumers are looking to the various web pages on the World Wide Web for information, services and products. However, with the inclusion of multimedia content, embedded advertising, and other online services, these web pages have become substantially more complex. By way of example, a web page may include additional peripheral information such as background imagery, advertisements, navigational menus, headers, footers, as well as separate links to additional content located throughout the World Wide Web.

It is, therefore, often the case that users of a web page desire to view, utilize or adapt the main content within the web page. Selecting or otherwise using that desired portion of the content on the web page requires that the user carefully distinguish between the desirable and undesirable content and retrieve those desirable portions of the web page. Additionally, various web sites and web pages not only vary widely by content, but any one web page may not contain the same information at any given time. Still further, users' preferences vary from user to user and therefore the desirable content to be selected may also vary depending on any one user's preferences. Selection of those portions of the website the user desires could greatly increase productivity as well as improve the user's experience while accessing the web page.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIG. 1 is a diagram of an illustrative system for selection of user desirable content in web pages based on other users' past content selections, according to one example of principles described herein.

FIG. 2A is a Document Object Model (DOM) tree for an illustrative web page, according to one example of principles described herein.

FIG. 2B is a layout of an illustrative web page which corresponds to the Document Object Model (DOM) tree of FIG. 2A, according to one example of principles described herein.

FIG. 2C is diagram of an illustrative web page showing the content of the web page of FIGS. 2A and 2B, according to one example of principles described herein.

FIG. 3 is an illustrative chart depicting a method of extracting user desirable content from a web page based on the popular content selections previously made by other users, according to one example of the principles described herein.

FIG. 4 is an illustrative diagram of the web page of FIG. 2C, showing a selection of additional web page content, according to one example of principles described herein.

FIG. 5 is an illustrative diagram of the web page of FIG. 2C, showing a selection of additional web page content, according to one example of principles described herein.

FIG. 6 is an illustrative flowchart depicting another method of extracting user desirable content from a web page based on the popular content selections previously made by other users, according to one example of the principles described herein.

Throughout the drawings, identical reference numbers designate similar, but not necessarily identical, elements.

### DETAILED DESCRIPTION

The present specification discloses various methods, systems, and devices for determining the user desirable or main content of a web page using previous markups of content selections made within similar web pages, Specifically, the present specification discloses various methods, systems and devices for determining the user desirable content of a web page based on popular content selections previously made by all users who have accessed the web page previously. As discussed earlier, there exist various types of content on any given web page that a user of a web page may not necessarily want to utilize. Some of the potentially unwanted content may include background image, advertisements, navigational menus, headers, footers, as well as separate links to additional content located throughout the World Wide Web. Therefore, it is more advantageous for a user having accessed a web page to be able to select those portions of the web page that he or she wants to edit, view, print, present or otherwise utilize. Additionally, it is also advantageous to save any data relating to those portions of web page content previously selected by all users who have accessed the web page for utilization by other users. Therefore, when the user of the web page accesses the same or a similar web page, the user desirable content of a web page is selected based, at least partially, on the content previously selected for that web page or a similar web page by all users who had previously accessed the web page.

As used herein, the term “includes” means includes but not limited to, the term “including” means including but not limited to. The term “based on” means based at least in part on.

As briefly discussed earlier, various challenges arise in attempting to manually select user desirable content from a web page. One challenge is the various types of web pages used. Specifically, many different templates are used to create the various types of web pages on the World Wide Web and this may add additional difficulty in trying to access the user desirable content in a more convenient way, Similarly, another challenge arises when attempting to select the user desirable content from web pages which may be arbitrary because the web page does not include a template at all.

It is further challenging to select the user desirable content of the web page when most web pages on the World Wide Web include various types of content such as text, images, videos and flash object. Typically, a user may not want included these types of content with the user desirable content. Therefore, determining what is and is not user desirable content can be difficult if all of these types of content are present in any given web page, In one illustrative example, an algorithm may be used to not only determine a relative ordering of level of appeal of content but also to determine whether content can be categorized as “user desirable” content.

As used in the present specification and in the appended claims, the term “web page” is meant to be understood broadly as any document that can be accessed by a Uniform Resource Locator (URL) on the World Wide Web. A web page may, therefore, be retrieved from a server over a network connection and viewed in a web browser application.

Additionally, as used in the present specification and in the appended claims, the term “user” is meant to be understood broadly as any person viewing a web page. Therefore, an owner or administrator of a web page, a user of a computing system having accessed a web page, or any other person may be a user.

Still further, as used in the present specification and in the appended claims, the terms “main content,” “user desirable content,” or “viewer desirable content” are meant to be understood broadly as that content on a web page which a user or viewer wishes to view, utilize, or adapt for any purpose. Indeed, the present specification may refer to “desirable” content within a web page which is meant to be understood as those sections of text, images, or any other content on a web page which the user may generally wish to view, utilize or adapt and which is separate from any other undesirable content within a web page. In one example of the present specification, the method of determining what content within the web page is to be selected, to determine the web page data selected most often, may utilize an algorithm that aggregates the statistical distribution of what parts of the web page have been selected previously.

Even further, as used in the present specification and in the appended claims, the term “web page data” is meant to be understood broadly as any data relating to a web page. For example, web page data may include at least one of the web page's Uniform Resource Locator (URL); the web page's Document Object Model (DOM); information misting to the structure and layout of a Document Object Model (DOM) tree of the web page; the layout and structure of any nodes within the Document Object Model (DOM) tree; content of a web page or nodes previously or currently selected by a user within a Document Object Model (DOM) tree; content of a web page or nodes not previously or currently selected by a user within a Document Object Model (DOM) tree; any data relating to the amount or characteristics of any type of content of the web page selected or not selected by an individual, entity; or combinations of these. Web page data may additionally include any metadata associated with or describing any of the above mentioned types of data. Still further, web page data may also include any data or metadata relating not only to the content of a web page an individual has selected from any one web page in the past, but may also include information relating to when, and how often the user had previously viewed, utilized, or adapted a web page or content on a web page.

Further, as used in the present specification and in the appended claims, the term “sub-node” is meant to be understood broadly as any node within a Document Object Model (DOM) tree which, has at least one de located on a higher level in the hierarchal order of the Document Object Model (DOM) tree. Therefore, a sub-node may be a sub-node of a node which itself is a sub node. Additionally, a sub-node may also comprise or have associated with it a number of sub-nodes itself.

Still further, as used in the present specification and in the appended claims, the term “similar web page” is meant to be understood broadly as any web page having similar characteristics as compared to another web page. For example, a similar web page may be similar in the type of template used to arrange the text, images or other content displayed on the web page. A similar web page may also be similar because, although the web page address or Uniform Resource Locator (URL) is not entirely identical, the domain name within the Uniform Resource Locator (URL) is the same. Additionally, a similar web page may be similar in the content displayed on the web page. Similarly, as used in the present specification and in the appended claims, the terms “equivalent web page data” or “similar web page data” is meant to be understood broadly as any web page data having similar characteristics as compared to other web page data. For example, a number of web pages' Document Object Model (DOM) trees may contain certain nodes which are similar to each other because, for example, the content contained in those respective nodes are equivalent.

Further, as used in the present specification and in the appended claims, the terms crowd consensus or “popular content” are meant to be understood broadly as any content within a web page collected by any method and associated algorithms that aggregates the statistical distribution of what parts of a web page have been selected previously, and which further determines what portions of the web page are considered to be most popular or are part of a consensus of one or more people. For example, the crowd consensus or popular content may be determined by a frequency count, a voting scheme, a weighted counting scheme, a ranking of a type of selection, or combinations thereof, among others. In one example, a crowd consensus or popular content may be made by any number of persons including, for example, a user, other users, or combinations of these. Also, a crowd consensus or popular content may be based on, for example, how often a portion of a web page was selected, what portion or portions of a web page were selected, how consistently a particular portion of a web page was selected, various types of statistical correlations between how related portions of a web page were selected, the weight of the portions of the web pages that were selected, a rank of a type of selection made within the web page, or combinations thereof, among others.

Additionally, as used in the present specification and in the appended claims, the term “hash” is meant to be understood broadly as any number generated from a string of data, indeed, a “hash function” is meant to be understood as any function that is used to convert data into small datum which may serve as an index. Specifically, a hash may be a conversion of web page data associated with a web page into smaller datum which may then be placed in a table or database for easy lookup.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with the example is included in at least that one example, but not necessarily in other examples. The various instances of the phrase “in one example” or similar phrases in various places in the specification are not necessarily all referring to the same example.

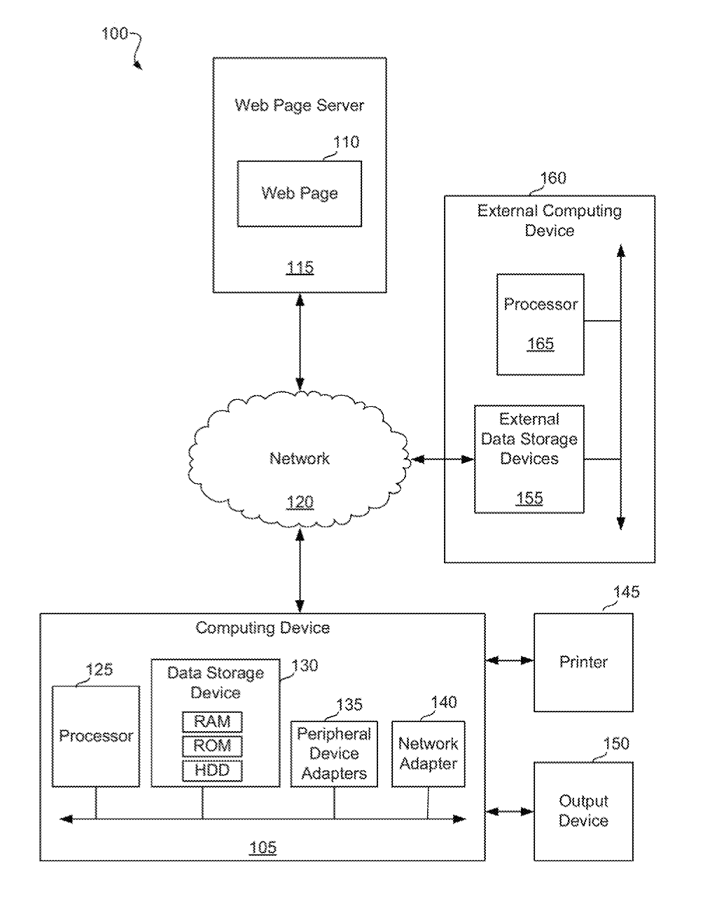

Referring now to FIG. 1, an illustrative system (100) for selection of user desirable content in web pages (110) based on other users' past content selections includes a computing device (105) that has access to a web page (110) stored by a web page server (115). In the present example, for the purposes of simplicity in illustration, the computing device (105) and the web page server (115) are separate computing devices communicatively coupled to each other through a mutual connection to a network (120). However, the principles set forth in the present specification extend equally to any alternative configuration in which a computing device (105) has complete access to a web page (110). As such, alternative examples within the scope of the principles of the present specification include, but are not limited to, examples in which the computing device (105) and the web page server (115) are implemented by the same computing device, examples in which the functionality of the computing device (105) is implemented by multiple interconnected computers (for example, a server in a data center and a user's client machine), examples in which the computing device (105) and the web page server (115) communicate directly through a bus without intermediary network devices, and examples in which the imputing device (105) has a stored local copy of the web page (110) which is to be analyzed to select the desirable content from the web page (110).

Additionally, for purposes of simplicity, the web page of tike present example is stored on a single web server. However, the principles set forth in the present specification may include web pages which are generated dynamically from pieces of web page content stored on a number of various types of storage devices. For example, a web page of the present specification may be generated by a cluster of individual communicating servers. Still further, a web page of the present specification may also be generated dynamically by data computed on the fly.

The illustrative system may further include an external computing device (160) that stores web page data associated with any web page accessed by a user of the computing device (105). Therefore, in one illustrative example, the external computing device (160) and the computing device (105), being connected through the network (120) may work together to provide to a user of the computing device (105) selected portions of a web page based, at least, on previous selections made by other users who have accessed the same or similar web pages.

The computing device (105) of the present example is a computing device that retrieves the web page (110) hosted by the web page server (115) and presents to the user, through an output device (150) at least part of the web page. In the present example, this is accomplished by the computing device (105) requesting the web page (110) from the web page server (115) over the network (120) using the appropriate network protocol, for example, Internet Protocol (IP). Illustrative processes for identifying the most user desirable content of the web page (110) are set forth in more detail below.

To achieve its desired functionality, the computing device (105) includes various hardware components. Among these hardware components may be at least one processor (125), at least one data storage device (130), peripheral device adapters (135), an output device (150) such as a monitor, a printer (145), and a network adapter (140). These hardware components may be interconnected through the use of one or more busses and/or network connections.

The processor (125) may include the hardware architecture necessary to retrieve executable code from the data storage device (130) and execute the executable code. The executable code may, when executed by the processor (125), cause the processor (125) to implement at least the functionality of retrieving the web page (110) and present to the user the user desirable content of the web page (110) according to the methods of the present specification described below. In the course of executing code, the processor (125) may receive input from and provide output to one or more of the remaining hardware units.

The data storage device (130) may store data which is processed and produced by the processor (125). As will be discussed, the data storage device (130) may specifically save web page data including, for example, a web page's Uniform Resource Locator (URL), Document Object Model (DOM) tree, and sections of content in a web page a user has selected. All of this data may further be stored in the form of a database for easy retrieval when the same or a similar web page is once again accessed by a user.

The data storage device (130) may include various types of memory modules, including volatile and nonvolatile memory. For example, the data storage device (130) of the present example includes Random Access Memory (RAM), Read Only Memory (ROM), and Hard Disk Drive (HDD) memory. Many other types of memory are available in the art, and the present specification contemplates the use of many varying type(s) of memory (130) in the data storage device (130) as may sprit a particular application of the principles described herein. In certain examples, different types of memory in the data storage device (130) may be used for different data storage needs. For example, in certain examples the processor (125) may boot from Read Only Memory (ROM), maintain nonvolatile storage in the Hard Disk Drive (HDD) memory, and execute program code stored in Random Access Memory (RAM).

Generally, the data storage device (130) may comprise a computer readable storage medium. For example, the data storage device (130) may be, but not limited to, an electronic, magnetic, optical, electromagnetic, infrared, or semiconductor system, apparatus, or device, or any suitable combination of the foregoing. More specific examples of the computer readable storage medium may include, for example, the following an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

The hardware adapters (135, 140) in the computing device (105) enable the processor (125) to interface with various other hardware elements, external and internal to the computing device (105). For example, peripheral device adapters (135) may provide an interface to input/output devices to create a user interface and/or access external data storage dev (155). Specifically, the peripheral device adapters (135) may provide and interface to an output device (150) such as a monitor to allow a user to interact with and adjust the amount and type of content selected within a web page (110).

Peripheral device adapters (135) may also create an interface between the processor (125) and a printer (145) or other media output device. For example, here the computing device (105) selects the most user desirable content of the web page (110) and the user then wishes to print that content, the computing device (105) may instruct the printer (145) to create one or more physical copies of the document. A network adapter (140) may additionally provide an interface to the network (120), thereby enabling the transmission of data to and receipt of data from other devices on the network (120), including the web page server (115).

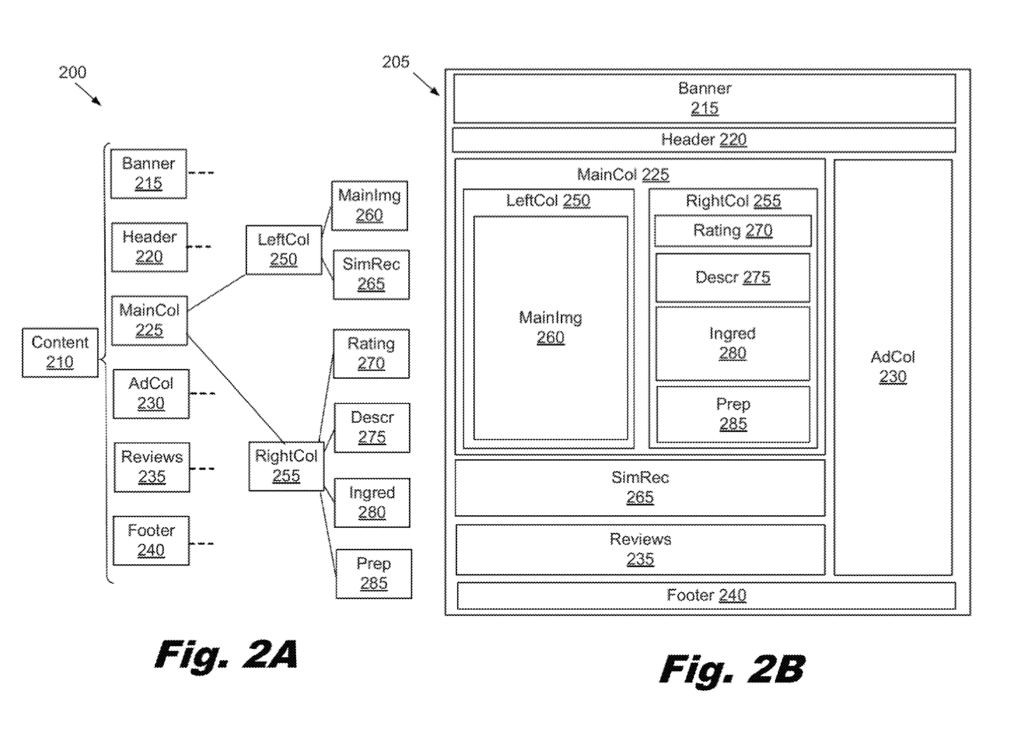

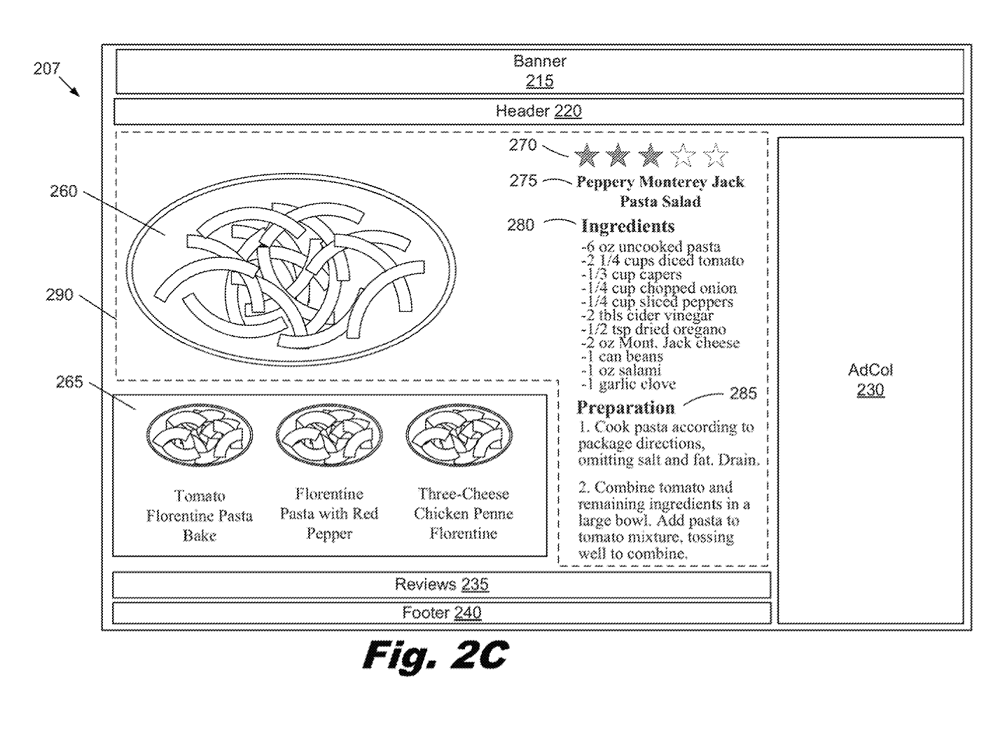

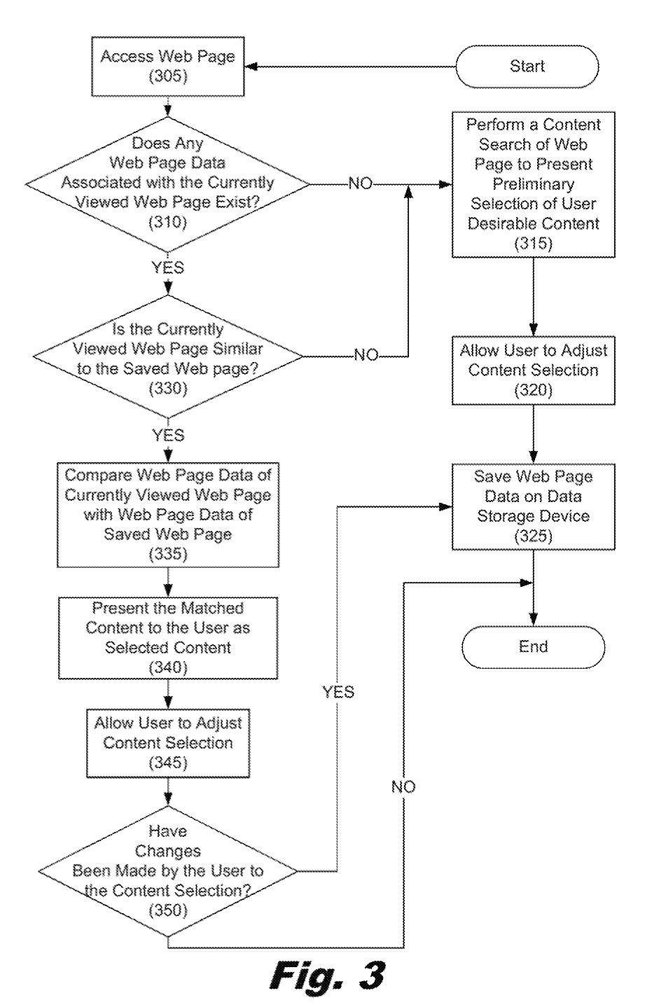

Referring now to FIGS. 2A-2C, a Document Object Model (DOM) tree for an illustrative web page, the web page layout, and the visual elements in a web page is shown. As discussed earlier, various types of data associated with a web page may exist. This data may be saved on an external data storage device (160) in order to allow for better selection of the user desirable content of a web page. However, for purposes of explanation only, the present specification uses the illustrative example of saving a Uniform Resource Locator (URL), the web page associated with the Uniform Resource Locator (URL), the web page's Document Object Model (DOM) tree, the particular nodes selected by a user, or combinations thereof. Therefore, although the illustrative example in the present specification and specific ally connection with FIGS. 2A-2C may only refer to these types of data being saved in order to better select the appropriate user desirable content from a web page, it can be appreciated that any type of web page data may also be saved so as to achieve similar results. For example, the present system, method and device described may save any representation of a web page Document Object Model (DOM) tree, any transformation of a web page Document Object Model (DOM) tree, any hash table created by the use of a hash function and meant to represent any selected content of a web page, any modifications of a previous Document Object Model (DOM) tree, or any other type of data representing any content on any web page which has been previously selected by a user. It can be appreciated, therefore, that any data representing selected content of a web page may be stored in a data storage device (FIG. 1, 130, 155) for future reference by a processor (FIG. 1, 125) so as to select user desirable content within a web page.

In the example shown in FIGS. 2A-2C, the web page is from a recipe website and includes an image of the dish which is described, a rating of the dish by users of the web page, a description of the dish, ingredients to make the dish, preparation instructions, and other elements.

FIG. 2A is an illustrative Document Object Module (DOM) tree (200) showing the hierarchy of Document Object Module (DOM) nodes in the illustrative web page. A Document Object Module (DOM) is a cross-platform and language independent convention for representing and interacting with web page elements in HyperText Markup Language (HTML), eXensible HyperText Markup Language (XHTML) and eXensible Markup Language (XML). The root node in this illustrative web page is the Content (210) node which, in this example, has six sub-nodes: the Banner (215) sub-node; Header (220) sub-node, MainCol (225) sub-node; AdCol (230) sub-node; Reviews (235) sub-node; and Footer (240) sub-node. For purposes of illustration, sub-nodes (250-235) are shown only for the MainCol (225) sub-node. Therefore, it can be appreciated that the Banner (215) sub-node, Header (220) sub-node, AdCol (230) sub-node, Reviews (235) sub-node, and Footer (240) sub-node may each include additional sub-nodes of their own, Dashed lines extending to the right of the other sub-nodes therefore show the continuation of the sub-nodes with nodes which are not illustrated in FIG. 2A.

The MainCol (225) sub-node also includes two sub-nodes itself, LeftCol (250) sub-node and RightCol (225) sub-node, at the next hierarchal level. LeftCol (250) sub-node has two sub-nodes at the lowest hierarchal level: Mainimg (260) sub-node and SimRec (265) sub-node. The RightCol (225) sub-node has four sub-nodes at the lowest hierarchal level: Rating (270) sub-node, Descr (275) sub-node, Ingred (280) sub-node, and Prep (285) sub-node.

FIG. 2B shows the layout (205) of the illustrative web page depicted by the Document Object Module (DOM) tree (FIG. 2A, 200) shown in FIG. 2A. The Banner (215) and AdCol (230) each hold a location within the layout (205) for a banner ad and other advertisements. The Header (220) may contain a number of elements including navigation tabs, search fields and other sub-elements. Similarly the Footer (240) may contain a number of elements including links to related sites, terms of use and privacy policies, copyright notices, and other elements. The Reviews (235) sub-tree may contain ratings and comments from various users of the site who have tried the recipe. However, as explained above, for simplicity these elements within the Banner (215): AdCol (230), Header (220), Footer (240) and Reviews (235) are not represented on the Document Object Model (DOM) tree of FIG. 2A and therefore also do not appear in the web page layout of FIG. 2B.

The MainCol (225) sub-node contains at least some of the user desirable content which a user may want to view, utilize or adapt. The MainCol (225) contains a left column (250) and a right column (255). in left column (250), an image is shown in the Mainimg (260) element; in this illustrative example the image is a dish. The right column (255) includes an overall rating for the dish (270), a description of the dish (275), ingredients of the dish (280), and preparation instructions (285). Similar recipes are shown below the MainCol (225) in the SimRec (265) element. These elements (260-285) may also have a number of additional sub-elements.

FIG. 2C is diagram of an illustrative web page (207) showing the content of the web page of FIGS. 2A and 2B. The content has been simplified for purposes of illustration. There may be a variety of non-visual code and/or elements present in any of the elements (FIG. 2B, 215-285). However, according to one aspect of the present systems and methods this non-visual information is not presented to the user viewing the web page (207) as being part of the user desirable content. Consequently, during the analysis of the web page (207) to determine the user desirable content of the web page (207), non-visual information is not weighted heavily or is not considered at all. As discussed above the user is typically interested in viewing, utilizing or adapting in some way the main content (290) of the web page (207). Banner ads, page navigation, reviews, and links typically contain information which is not directly relevant to the user's interest in the web page (207) and are not directly related to the content the user wishes to view, utilize or adapt.

Turning now to FIG. 3, an illustrative flowchart depicting a method of extracting user desirable content from a web page (FIG. 1, 110; FIG. 2C, 207) based on the popular content selections previously made by other users is shown. The method starts by accessing or downloading a web page (FIG. 1, 110; FIG. 2C, 207) to a computing device (FIG. 1, 105) operated by a user (Block 305). Accessing a web page (FIG. 1, 110; FIG. 2C, 207) is typically accomplished with a we browser program stored on the computing device (FIG. 1, 105). As discussed earlier this computing device (FIG. 1, 105) may retrieve the web page (FIG. 1, 110; FIG. 2C, 207) hosted by the web page server (FIG. 1, 115) and determine the most user desirable content of the web page (FIG. 1, 110; FIG. 2C, 207) based, at least partially, on web page data stored on an external data storage device (FIG. 1, 160). The web page data describes other users' previous selections of text, images and other content on the same or a similar web page as that being accessed by the user. In the present example, access to the web page (FIG. 1, 110; FIG. 2C, 207) is accomplished by the computing device (FIG. 1, 105) requesting the web page (FIG. 1, 110; FIG. 2C, 207) from the web page server (FIG. 1, 115) over the network (FIG. 1, 120) using the appropriate network protocol, for example, Internet Protocol (IP).

Next, it is determined (Block 310) whether any web page data had been previously saved on the external data storage device (FIG. 1, 160) which is, at least, similar to the web page data of the current web page (FIG. 1, 110; FIG. 2C, 207) being accessed. As discussed previously, the web page data may come in the form of a Uniform Resource Locator (URL), a Document object Model (DOM) tree, or any other type of web page data and may be stored and accessed in a way so as to be compared with any other web page data associated with other accessed web pages. This is done so as to first determine if such web page data exists (Block 310) and then, if it does, to next determine (Block 330) if the web page data associated with the currently viewed web page is similar to any saved web page data associated with at least one previously accessed web page.

As will be discussed below, the external data storage device (FIG. 1, 155) is a data storage device capable of being accessed by multiple users. This is done so that any one user's computing device (FIG. 1, 105) may access the web page data defining the content selected by other users who had previously accessed the same or similar web page. Therefore, the user may take advantage of other users' previous content selections from the various web pages and thereby receive selections of user desirable content based at least partially on those past selections by other users. The external data storage device (FIG. 1, 155) may be accessed via the network (FIG. 1, 120) and may therefore be external to all users' computing devices (FIG. 1, 105). In an alternative example, the external data storage device (FIG. 1, 155) may be integrated with either the web page server (FIG. 1, 115) or at least one of the users' computing device (FIG. 1, 120).

If, for example, the current web page (FIG. 1, 110; FIG. 2C, 207) being viewed had not been accessed by any user earlier, any we page data relating to that web page (FIG. 1, 110; FIG. 2C, 207) may not have been saved for access by the individual users' computing devices (FIG. 1, 105). When this occurs (Determination NO. Block 310), the users computing device (FIG. 1, 105) may perform a content search of the web page to present a preliminary selection of user desirable content (Block 315). Content selection may be performed via a number of methods; however, in one example an algorithm may be implemented by the computing device (FIG. 1. 105) to select the most user desirable portions of the web page (FIG. 1, 110; FIG. 2C, 207).

One method of selecting user desirable content from a web page (FIG. 1, 110; FIG. 2C, 207) may include, first, segmenting the web page (FIG. 1, 110; FIG. 2C, 207) into several coherent areas or blocks. For example, the computing device (FIG. 1, 105) may access the source code of the web page (FIG. 1, 110; FIG. 2C, 207) to determine or create a Document Object Model (DOM) tree (FIG. 2A, 200) for the web page (FIG. 1, 110; FIG. 2C, 207), gather information about each node on the Document Object Model (DOM) tree (FIG. 2A, 200), and segment the web page (FIG. 2C, 207) into coherent areas or blocks. The computing device (FIG. 1, 105) may also eliminate or filter out any invisible elements of the web page (FIG. 1, 110; FIG. 2C, 207) which may not need to be included with the main content of e web page (FIG. 1, 110; FIG. 2C, 207).

The computing device (FIG. 1, 105) may then calculate a score for each area or block based on many features of the web page (FIG. 1, 110; FIG. 2C, 207). For example, a score may be calculated based on the horizontal and vertical coverage of each block, the normalized text length within each block, the link-to-text ratio within each block, the ratio of non-highlighted text to highlighted text within each block, the normalized block area, and the normalized number of any child Document Object Model (DOM) nodes within each block. The horizontal coverage may be obtained by computing the horizontal extent of a segment over the total area of the page. The blocks covering near the horizontal center get higher scores. Similarly, the vertical coverage may be obtained by computing the vertical extent of a segment over the total area of the page. The blocks covering near the top of the web page (FIG. 1, 110; FIG. 2C, 207) have higher scores. The normalized text length may be obtained by computing the text length of the segment over the maximal text length of all segments. The link-to-text ratio may be obtained by computing the link text length of the segment over the text length of the segment. Texts with higher density of anchor text are more likely to be a navigational bar or an advertisement. Similarly, the non-highlighted text to highlighted text ratio may be obtained by computing the highlight text length of the segment over the text length of the segment and then multiplying the highlight weight. For example, the weight of <H1>is larger than <H6>. The normalized block area may be obtained by computing the segment area over the maximal area of all segments. Further, the normalized number of child (DOM) nodes may be obtained by computing the number of child nodes in the segment over the maximal number of child nodes in all segments.

Next, the computing device (FIG. 1, 105) may determine which areas or blocks have received the highest score and present those areas with a score high enough to overcome a predetermined threshold limit to a user via a user interface such as a monitor. The main content (FIG. 2C, 290) is then selected without any user interaction. Therefore, the selection of these selected portions of the web site (FIG. 2C, 207) may be done in the background while the web page (FIG. 1, 110; FIG. 2C, 207) is being accessed by the user.

In another example, the selection of the most often selected portions of the web page (FIG. 1, 110; FIG. 2C, 207) may be performed using a threshold. In this example, portions of the web page (FIG. 1, 110; FIG. 2C, 207) associated with particular nodes within the Document Object Mod& (DOM) tree (FIG. 2A, 200) are selected at least a threshold amount of times by other users who had accessed the web page (FIG. 1, 110; FIG. 2C, 207) or a similar web page. Again, this threshold may be predetermined by the client device (FIG. 1, 105), or may be selected by the user. For example, if a portion of the web page (FIG. 1 110; FIG. 2C, 207) associated with particular node is selected by other users at least ten times, then that portion of the web page is presented to the user as a popular content selection.

In another example, the selection of the most often selected portions of the web page (FIG. 1, 110; FIG. 2C, 207) may be performed using a fraction of times a particular portion of the web page (FIG. 1, 110; FIG. 2C, 207) was selected. In this example, if a particular node or other portion of the web page has been selected a number of times more than other portions of the web page above a predetermined fraction, then that portion of the web page is presented to the user as a crowd consensus or popular content selection. In one example, the fraction may be higher than about 0.8. In another example, the fraction may be higher than about 0.6.

Further, in yet another example, the selection of the most often selected portions of the web page (FIG. 1, 110; FIG. 2C, 207) may be performed using a variance of a selection of a portion of the web page (FIG. 1, 110; FIG. 2C, 207). In this example, it may first be determined how consistently a particular node or portions of the web page (FIG. 1, 110; FIG. 2C, 207) is selected. In still another example, the selection of the most popular portions of the web page (FIG. 1, 110; FIG. 2C, 207) may be performed using correlations between how related nodes or portions of the web page (FIG. 1, 110; FIG. 2C, 207) are selected.

Still further, in other examples, the selection of the most often selected portions of the web page (FIG. 1, 110; FIG. 2C, 207) may be determined by a weighted count of a selection by its type, as a median of certain types of selections, or some other voting scheme. For example, more weight may be given to a specific node within the Document Object Model (DOM) tree (FIG. 2A, 200) based on the content contained or described in that node. Therefore, if a website contains generally news article, for example, the main article may be given more weight than other articles listed on the web page and may, therefore, be presented to the user over other portions of the web page. In another example, the type of content contained within one node may also determine what weight to give a node and thereby may determine whether a node is included in the selected content or not. Even further, in other examples, the selection of the most often selected portions of the web page (FIG. 1, 110; FIG. 2C, 207) may be determined by using an algorithm that aggregates the statistical distribution of what parts of the web page has been selected previously and then presents those selections to the user.

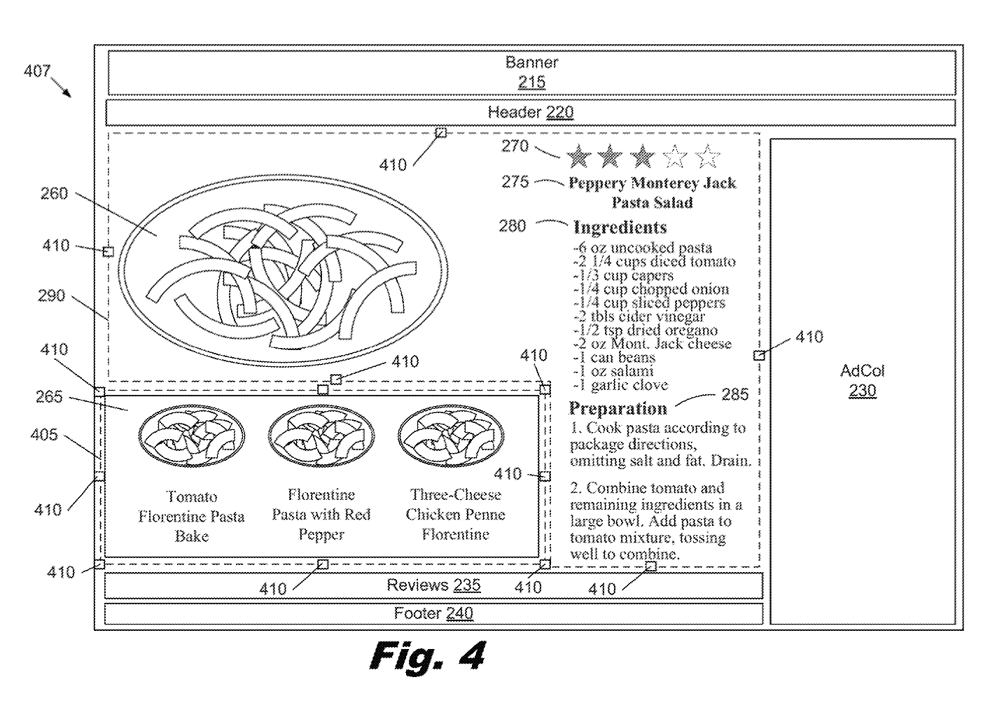

After the computing device (FIG. 1, 105) has performed a content search of the web page (Block 315) to present a preliminary selection of user desirable content, the user may then be allowed to adjust the amount of content to be selected (Block 320) within the web page (FIG. 1, 110; FIG. 2C, 207). Still looking at FIG. 3 and now turning to FIG. 4, an illustrative diagram of the illustrative web page of FIG. 2C showing a selection of additional web page content (405) is shown. In addition to the selected main content (290) of the web page (207), the user may select additional content (405) of the web page (207). Specifically, this may be done by clicking on and dragging a number of control points (410) located around or otherwise associated with the selected main content (290) shown on the user interface of the computing device (FIG. 1, 105). In this manner, the user may include additional content to the selected main content (290) of the web page (207) by dragging, for example, a corner or side control point (410) of the main content (290) over additional portions of the web page (207). Further, the user may restrict the amount of content included in a selected portion by dragging the control points (410) off of portions of the main content (290) of the web page (207). Still further, the user may be allowed to drag a cursor over additional portions of the web page (207) so as to further select a separate portion of the web page (207) which is not dose to the selected portion (290). For example, expansion of the selected main content (290) of the web page may result in content which the user may not wish to include, but does include if the user is dragging a control point (410) over the unwanted content. In this case, the user may create a new block or section (405) within the content of the web page separate and distinct from the selected main content (290) while still excluding those undesirable sections positioned between those two sections of content. Therefore, this addition and subtraction of the selected portions within the web page provides for a more effective and user-friendly means of selecting those desirable portions of the web page (FIG. 1, 110, FIG. 2C, 207, FIG. 4, 207).

Looking now at FIG. 3 again, the method further includes saving any necessary web page data (Block 325) to an external data storage device (FIG. 1, 155) thereby allowing easy access to the web page data by a processor (FIG. 1, 125) on any users' computing device (FIG. 1, 105). Therefore, when any user accesses the web page (FIG. 1, 110, FIG. 2C, 207, FIG. 4, 407) or a web page similar to the web page (FIG. 1, 110, FIG. 2C, 207, FIG. 4, 407), the web page data representing the content previously selected by a user may be accessed and utilized to present to another user that user desirable content. As discussed above the web page data may be any type of data associated with the web page (FIG. 1, 110, FIG. 2C, 207, FIG. 4, 407) which allows a computing device (FIG. 1, 105) to select those user desirable portions of a web page (FIG. 1, 110, FIG. 2C, 207, FIG. 4, 407). For example, web page data may include the web page's (FIG. 1, 110, FIG. 2C, 207, FIG. 4, 407) Uniform Resource Locator (URL); the web page's (FIG. 1, 110, FIG. 2C, 207, FIG. 4, 407) Document Object Model (DOM) (FIG. 2A, 200); information relating to the structure and layout of a Document Object Model (DOM) tree (FIG. 2A, 200) of the web page (FIG. 1, 110, FIG. 2C, 207, FIG. 4, 407); the layout and structure of any nodes within the Document Object Model (DOM) tree (FIG. 2A, 200); content of a web page (FIG. 1, 110, FIG. 2C, 207, FIG. 4, 407) or nodes previously or currently selected by a user within a Document Object Model (DOM) tree (FIG. 2A, 200); content of a web page (FIG. 1, 110, FIG. 2C, 207, FIG. 4, 407) or nodes not previously or currently selected by a user within a Document Object Model (DOM) tree (FIG. 2A, 200); any data relating to the amount or characteristics of any type of content of the web page (FIG. 1, 110, FIG. 2C, 207, FIG. 4, 407) selected or not selected by an individual, entity: or combinations of these. Web page data may additionally include any metadata associated with or describing any of the above mentioned types of data. Still further, web page data may also include any data or metadata relating not only to the content of a web page an individual has selected from any one web page (FIG. 1, 110, FIG. 2C, 207, FIG. 4, 407) in the past, but may also include information relating to when and how often the user had previously viewed, utilized, or adapted a web page or content on a web page (FIG. 1, 110, FIG. 2C, 207, FIG. 4, 407).

The web page data stored on the external data storage device (FIG. 1, 155) may then be retrieved again at a later time by the processor (FIG. 1, 125) located on the computing device (FIG. 1, 105) so as to better select the user desired content of the web page (FIG. 1, 110, FIG. 2C, 207, FIG. 4, 407) based on those portions of the web page (FIG. 1, 110, FIG. 2C, 207, FIG. 4, 407) selected by previous users. Therefore, if any user had previously accessed the web page (FIG. 1, 110, FIG. 2C, 207, FIG. 4, 407) and web page data relating that web page (FIG. 1, 110, FIG. 20, 207, FIG. 4, 407) does exist (Determination YES, Block 310), then the computing device (FIG. 1, 105) may determine whether the web page data of the web page (FIG. 1, 110, FIG. 2C, 207, FIG. 4 407) being accessed is similar to any of the web page data of a previously accessed web page (Block 330). This may be done by allowing the computing device (FIG. 1, 105) to access the external data storage device (FIG. 1, 155) associated with the web page data and compare data relating to the currently accessed web page (FIG. 1, 110, FIG. 2C, 207, FIG. 4, 407) with data relating to any previously accessed web page. For example, the computing device (FIG. 1, 105) may compare the Uniform Resource Locator (URL) of the currently accessed web page (FIG. 1, 110, FIG. 20, 207, FIG. 4, 407) with any other saved Uniform Resource Locator (URL) related or associated with a previously accessed web page. Any web page data saved on the database relating to that. Uniform Resource Locator (URL) is then compared (Block 330) with the web page data of the currently assessed web page (FIG. 1, 110, FIG. 2C, 207, FIG. 4, 407). As described above, a crowd consensus or popular content selection may be determined by any method and associated algorithms that aggregate the statistical distribution of what parts of a web page have been selected previously, and determines what portions of the web page are considered to be most popular or are part of a consensus of one or more people. These methods of determining the crowd consensus or popular content selection may include, for example, by a frequency count, a voting scheme, a weighted counting scheme, a ranking of a type of selection, or combinations thereof, among others.

Often, the layout of the content within a web page or even a template used in creating a web page may change over a period of time. For instance, an operator or owner of a web page may want to adjust the look of a web page and in so doing may use a different template or at least adjust the placement of the content on the web page. Therefore, when any user has accessed a web page before these changes were implemented; had saved the necessary web page data for future use; and the same or different user revisited the web page again after the web page was altered or adjusted, the web page data may not be similar enough to once again effectively obtain from the web page the user desirable content. In this case (Determination NO, Block 330), the web page (FIG. 1, 110, FIG. 2C, 207, FIG. 4, 407) is treated as if no user had ever previously accessed the web page (FIG. 1, 110, FIG. 20, 207, FIG. 4, 407) and the method described above in connection with Blocks 315 through 325 are repeated again for this web page. Specifically, a content selection algorithm is ran (Block 315) to obtain user desirable content from the web page (FIG. 1, 110, FIG. 2C, 207, FIG. 4, 407), the user is allowed to adjust (Block 320) the selected content (FIG. 2C, 290) to his or her preferences, and the web page data is again saved and stored on the data storage device (FIG. 1, 130) in an external data storage device (Block 325).

If, however, the web page data of the currently accessed web page (FIG. 1, 110, FIG. 2C, 207, FIG. 4, 407) is similar enough to the web page data previously stored in the database (Determination YES, Block 330), the the computing device (FIG. 1, 105) may compare (Block 335) the web page data associated with the currently accessed web page (FIG. 1, 110, FIG. 2C, 207, FIG. 4, 407) with the content of the web page data associated with the previously accessed web page to see if there is any equivalent or similar web page data. As will be described later, the web page data associated with the previously accessed web page describes the popular content selections made by all past users who had accessed that web page in the past. After the computing device (FIG. 1, 105) has compared both sets of web page data, the computing device (FIG. 1, 105) may then present that most popular content to the user (Block 340) on an output device (FIG. 1, 110) such as a monitor for the user to store, print or otherwise utilize.

In another alternative example of the present specification, the web page data stored on the computing device (FIG. 1, 105) may comprise, at least, web page data relating to the most popular content of the web page which was not previously selected by a user; that data also being saved earlier in response to a user accessing that web page. Therefore, the computing device (FIG. 1, 105) may compare that web page data to the web page data associated with the web page (FIG. 1, 110, FIG. 2C, 207, FIG. 4, 407) currently being accessed and determine which content of the web page (FIG. 1, 110, FIG. 20, 207, FIG. 4, 407) to include and exclude from the content selection.

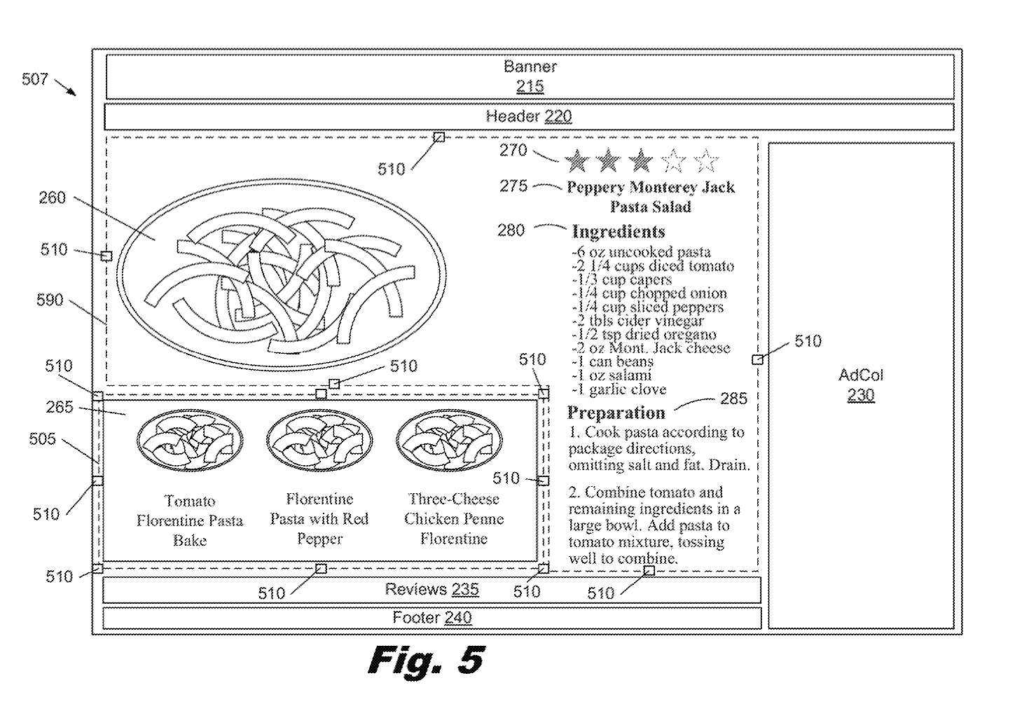

Similar to the method described in Block 320 above, after the matched portions of the web page have been presented to the user (Block 340), the user may further be allowed to adjust the content selection (Block 345). Again, still looking at FIG. 3 and now turning to FIG. 5, in addition to the content selected by the computing device based on previous selections made by the user (590), the user may select additional portions (505) of the web page (507). The user may further exclude portions of the web page (507) from being part of the user desirable content selection. Specifically, this may be done by clicking on and dragging a number of control points (510) located around or otherwise associated with the selected portion of the selected content shown on the user interface of the computing device (FIG. 1, 105). In this manner, the user may include additional portions of the user desirable portion of the web page (507) by dragging, for example, a corner or side control point (510) of the selected portion over additional portions of the web page (507). Further, the user may restrict the amount of content included in a selected portion by dragging the control points (510) off of portions of the selected content of the web page (507). Still further, the user may be allowed to drag a cursor over additional portions of the web page (507) so as to further select a separate portion of the web page (507) which is not close to the previously selected portion (590). For example, expansion of the previously selected portion of the web page in order to include additional content may result in content which the user may not wish to include, but does include if the user is dragging a control point (510) over the unwanted content. In this case, the user may create a new block or section (505) within the content of the web page separate and distinct from the previously selected portion (590) while still excluding those undesirable sections positioned between those two portions. Therefore, this addition and subtraction of the previously selected portions (590) within the web page provides for a more effective and user-friendly means of obtaining those desirable portions of the web page (FIG. 1, 110; FIG. 2C, 207; FIG. 4, 407; FIG. 5, 507).

Once the user has had the opportunity to adjust the selection of the content in the web page (FIG. 1, 110; FIG. 2C, 207; FIG. 4, 407; FIG. 5, 507), the computing device determines (Block 350) if significant changes have been made by the user to the amount or type of content selected. These changes are compared to the initial content presented to the user after the computing device (FIG. 1, 105) had found and presented (Blocks 335 and 340) the popular content selections of content of the current web page (FIG. 1, 110; FIG. 2C, 207; FIG. 4, 407; FIG. 5, 507). Therefore, in one example, if the amount of content has been adjusted by any degree (Determination YES, Block 350), then the web page data representing the new amount and type of content selected by the user is stored on a database (Block 325) for future reference by the processor (FIG. 1, 125).

In another example, if the amount of content has been adjusted beyond a predetermined threshold (Determination YES, Block 350), then the web page data representing the new amount of content selected by the user is stored on a data storage device (Block 325) for future access by the processor (FIG. 1, 125). However, if the changes to the content selected by the user do not meet the predetermined threshold (Determination NO, Block 350), then the process ends without the web page data representing those adjustments being stored (Block 325).

Therefore, when the changes to the content selection by the user are significant enough (Determination YES, Block 350), the web page data and that web page data defining those changes are saved and stored once again for future use (Block 325) by any user accessing the web page (FIG. 1, 110; FIG. 2C, 207; FIG. 4; 407; FIG. 5, 507). Accordingly, when the changes are not significant enough (Determination NO, Block 350), the user had chosen those selected portions of the web page (FIG. 1, 110; FIG. 2C, 207; FIG. 4, 407; FIG. 5; 507) which were presented to the user (Block 340) and represents the most, popular user desirable content on that web page (FIG. 1, 110; FIG. 2C, 207; FIG. 4, 407; FIG. 5, 507).

In another example, if the user accepts the selections of popular content initially presented to the user without altering the selected portions, then computing device (FIG. 1, 105) may save to the external data storage device (155) web page data describing acceptance of the popularly selected portions. Therefore, the popularly selected portions of the web page may be given more weight when presenting those same portions to the user or another user in the future. In this manner, portions of a web page that represent the most user desirable content in that web page may be presented to future users accessing the web page.

In an alternative example of the method described in connection with FIG. 3, the user, because of privacy concerns, may be allowed to avoid saving any web page content he or she has selected to an external data storage device (FIG. 1, 155). In this case, because the user is unwilling to share the content selections made to the web page with other users, he or she would also not be allowed to take advantage of popular content selections of the group and therefore may instead be allowed to have the computing device (FIG. 1, 105) perform a content search of the web page to present a preliminary selection of user desirable content (Block 315). Therefore, the user may be incentivized, instead, to allow the computing device (FIG. 1, 105) to save to the external data storage device (FIG. 1, 155) that web page data defining those selections he or she has made; thereby taking advantage of the collective efforts of all of the other participating users.

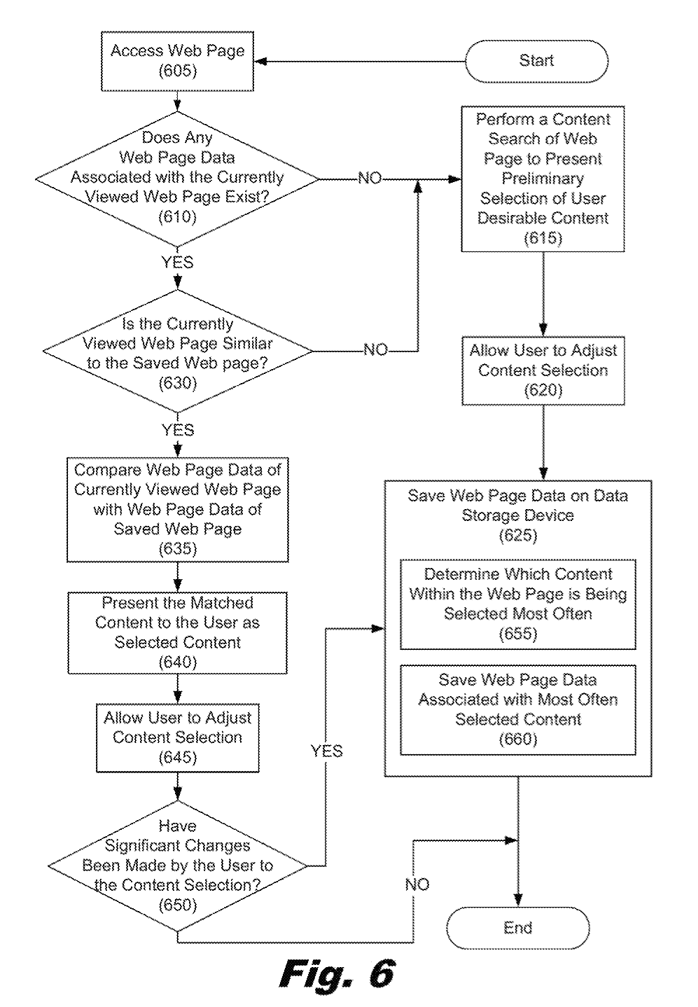

As described above in FIG. 3, multiple users may save any web page data associated with any particular web page (FIG. 1, 110; FIG. 2C, 207; FIG. 4, 407; FIG. 5, 507); the web page data defining the popular content selections by other users. In so doing, it can be appreciated that the web page data associated with any particular web page may be replaced with new web page data every time a new user accesses that web page (FIG. 3, Block 305) and makes adjustments to the amount of content selected (FIG. 3, Block 355) within the web page. These selections may, however, not necessarily represent the user desirable content for all users accessing the web page. Looking now at FIG. 6, an illustrative flowchart depicting another method of extracting user desirable content from a web page based on popular content selections previously made by other users is shown. Much like the method described above in connection with FIG. 3, the illustrative method depicted in FIG. 6 starts with a web page being accessed (Block 605) by a user through a computing device (FIG. 1, 105). The computing device then determines (Block 310) whether any web page data had been previously saved which is similar to the web page data of the current web page (FIG. 1, 110; FIG. 2C, 207) being accessed. If web page data does exist (Determination YES, block 610), they the computing device (FIG. 1, 105) determines whether the web page being currently viewed by the user is similar to a web page previously viewed (Block 630). If the web page data of the currently accessed web page 110, FIG. 2C, 207, FIG. 4, 407) is similar enough to the web page data previously stored (Determination YES, Block 630) in the external data storage device (FIG. 1, 155), then the computing device (FIG. 1, 105) may compare (Block 635) the web page data associated with the currently accessed web page (FIG. 1, 110, FIG. 2C, 207, FIG. 4, 407) with the content of the web page data associated with the saved web page defining the most popular content to see if there is any matching or similar web page data.

After the computing device (FIG. 1, 105) has compared both sets of web page data (Block 635), the computing device (FIG. 1, 105) may then present that matched or similar content to the user (Block 640) on an output device (FIG. 1, 110) such as a monitor for the user to store, print or otherwise utilize. Again, the user is further avowed to adjust the content selection (Block 645) as described above. If the amount of content has been adjusted beyond a predetermined threshold (Determination YES, Block 650), then the web page data representing the new amount of content selected by the user is stored on an external data storage device (Block 625) for future access by the processor (FIG. 1, 125). However, if the changes to the content selected by the user do not meet the predetermined threshold (Determination NO, Block 650), then the process ends without the web page data representing those adjustments being stored (Block 625).

Again, if the current web page (FIG. 1, 110; FIG. 2C, 207) being viewed had not been accessed by any user earlier, any web page data relating to that web page (FIG. 1, 110; FIG. 2C, 207) may not have been saved for access by the individual users' computing devices (FIG. 1, 105). When this occurs (Determination NO, Block 610), the users computing device (FIG. 1, 105) performs a content search of the web page similar to that content search described above. Again, this is done to present a preliminary selection of user desirable content (Block 61). In this case (Determination NO, Block 610) a content search of the presently viewed web page (FIG. 1, 110, FIG. 2C, 207, FIG. 4, 407; FIG. 5, 507) is performed (Block 615) to present a preliminary selection of user desirable content to the user.

Similarly, when the web page data associated with currently viewed web page (FIG. 1, 110; FIG. 2C, 207; FIG. 4, 407; FIG. 5, 507) is not similar to any web page data associated with the saved web page (Determination NO, Block 630), the web page (FIG. 1, 110, FIG. 2C, 207, FIG. 4, 407; FIG. 5, 507) is treated as if any user had never previously visited the web page (FIG. 1, 110, FIG. 2C, 207, FIG. 4, 407; FIG. 5, 507) before and a content search of the presently viewed web page (FIG. 1, 110, FIG. 2C, 207, FIG. 4, 407; FIG. 5, 507) is performed (Block 615) to present a preliminary selection of user desirable content to the user.

Similarly as described above in connection with FIG. 3, the user is again allowed to adjust the amount or type of content selected by the computing device (FIG. 1, 105) during the content search (Block 615). Therefore, the user may add or subtract material from the selection and save (Block 626) the web page data representing those new selections made by the user to the external data storage device (FIG. 1, 155).

However, unlike the illustrative method described in connection with FIG. 3, when the web page data representing the content selected by the user is saved (Block 625), either the computing device (FIG. 1, 105) or a computing device associated with the external data storage device (FIG. 1, 156) determines (Block 655) which content within the web page is being selected most often and saves (Block 660) that web page data associated with the content selected the most to the external data storage device (FIG. 1, 155).

In one example, the content selected most often is determined (Block 666) based on a scoring system. Specifically, a computing device may determine which nodes within the Document Object Model (DOM) tree (FIG. 2A, 200) representing content within the web page have been selected and then assign each node a score based on the number of times a user has selected that node in the past. Therefore, a high scored node may be included as part of the selected content while a low scored node may not.

Referring once again to FIG. 2C, an illustrative example of how this method may he accomplished will now be described. Once a command has been sent by the computing device (FIG. 1, 105) to save the web page data (Block 625), either the processor (FIG. 1, 125) associated with the computing device (FIG. 1, 105) or a processor associated with the external data storage device (FIG. 1, 155) may determine which nodes within the Document Object Model (DOM) tree (FIG. 2A, 200) represent those sections of the web page (FIG. 1, 110, FIG. 2C, 207) which the user had selected. Each node within the user selected portion (FIG. 2C, 290) is then given a score based on if and how often the node was selected in the past. For example, in FIG. 2C, the Main Image (FIG. 2C, 260) is part of the selected content (FIG. 2C, 290) and therefore should receive a point for being selected. However, the Main Image (FIG. 2C, 260) may also have been selected by all of the other users who had previously accessed the same web page. In that case, the Main Image node (FIG. 2A, 260) receives a very high score. However, in comparison, the Ratings (FIG. 2C, 270) section may not have been included in the selected content of the web page (FIG. 1, 110, FIG. 2C, 207) as often as that of the Main Image (FIG. 2C, 260) and may therefore receive a low score. In this manner, all nodes within the web page may be scored and the score associated with each node is saved (Block 660). In this example, the user may then be allowed to determine what level of scored selected content may appear as selected content. This may be done by allowing the user to set a threshold score level by which the most popular portions or nodes of the web page receiving the predetermined score may be shown as selected content whenever the web page is accessed again. As a beneficial consequence, all users' past selections of content within a web page can be used to compare (Block 635) the web page data of the currently viewed web page with the web page data associated with the saved web page and then present (Block 640) those portions of popular content to other users who access the web page in the future.

Referring again to FIG. 2C, another illustrative example of tow web page data representing the content within a web page may be accomplished will now be described. Again, a computing device associated with either the external data storage device (FIG. 1, 155) or the data storage device (FIG. 1, 130) may determine which content within the web page is being selected most often (Block 655). Web page data associated with the selected content most often selected is saved (Block 660). In this example, however, a fraction is calculated based off of the content or node most selected by all users who have accessed the web page. For example, the Main Image (FIG. 2C, 260) may be part of the selected content (FIG. 2C, 290) and therefore should receive a point each time it is selected by a user. If, for example, the Main Image (FIG. 2C, 260) had been included as the selected portion the most, the rest of the selected portions will have been selected by other users only a fraction of the time the Main Image (FIG. 2C, 260) had been selected. Therefore, if the Main Image (FIG. 2C, 260) had been selected by past users a total of twenty times and the Ratings (FIG. 2C, 270) had been selected a total of five times, the Ratings (FIG. 2C, 270) content or node are assigned a value of five twentieths or one fourth. However if the Ingredients (FIG. 2C, 280) section or node had been selected nineteen times, then the Ingredients (FIG. 2C, 280) section or node receive a score of nineteen twentieths. Again the user may be allowed to set a threshold limit on what content within the web page receiving a high enough fraction score may appear as selected content. In this way, content receiving a high enough fraction score is included as web page data in the future. Again, as a beneficial consequence, all users' past selections can be used to compare (Block 635) the web page data of the currently viewed web page with the web page data associated with the saved web page and then present (Block 640) those portions of popular content to the users who access the web page in the future.

In another example, as similarly described above, if the user accepts the popular content within the web page initially presented to the user without altering the selected portions, then computing device (FIG. 1, 105) may save to the external data storage device (155) web page data describing acceptance of the popularly selected portions. Therefore, the popularly selected portions of the web page may be given more weight when presenting those same portions to the user or another user in the future. In this manner, portions of a web page that represent the most user desirable content in that web page may be presented to future users accessing the web page.

It will be appreciated that although the methods of saving web page data to the external data storage device (FIG. 1, 155) described above are directed towards scoring a number of nodes within the Document Object Model (DOM) tree of the web page, it can be appreciated that other datum or data within the web page data may have a score assigned to them. This may be done so as to similarly provide a user accessing the web page in the future with the most user selected portions of the web page based on past selections from other users who had accessed the web page.

Additionally, the methods described above may be accomplished by a computer program product comprising a computer readable storage medium having computer usable program code embodied therewith that, when executed, performs the above methods. Specifically, the computer usable program code may determine whether any web page data exists that relates to the current web page (FIG. 1, 110; FIG. 2C, 207; FIG. 4, 407; FIG. 5, 507) being viewed by the user. The computer usable program code may further determine whether the web page data associated with the currently accessed web page (FIG. 1, 110; FIG. 2C, 207; FIG. 4, 407; FIG. 5, 507) is similar to any web page data associated with any previously accessed web pages. Still further the computer usable program code may present any web page data in common between the web page data associated with the currently accessed web page (FIG. 1, 110; FIG. 2C, 207; FIG. 4, 407; FIG. 5, 507) and any web page data associated with any previously accessed web pages. Further, the computer usable program code may interpret and store any changes made to the selected content within the web page (FIG. 1, 110; FIG. 2C 207; FIG. 4, 407; FIG. 5, 507) being accessed.

The specification describes and the figures illustrate a method of selecting content within a web page (FIG. 1, 110; FIG. 2C, 207; FIG. 4, 407; FIG. 5, 507) based on the content selected by other users who have accessed the web, page (FIG. 1, 110; FIG. 2C, 207; FIG. 4, 407; FIG. 5, 507). Specifically, the specification and figures describe a method of selecting content within a web page (FIG. 1, 110; FIG. 2C, 207; FIG. 4, 407; FIG. 5, 507) by matching web page data within a currently accessed web page with web page data associated with a previously accessed web page, and presenting, via a user interface, the matched content to a user. The web page data associated with the currently accessed web page is an accumulation of past users content selections. This method of selecting content within a web page (FIG. 1, 110; FIG. 2C, 207; FIG. 4, 407; FIG. 5, 507) may have a number of advantages, including: accuracy in the amount and type of user desirable content selected by the computing device; assimilation of user specific personal preferences as to the type and amount of content selected by the computing device; immediate accuracy in the amount and type of user desirable content selected by the computing device; selection of user desirable content based on the user's preferences without further interaction by the user; and, increase in privacy because the web page data saved by the computing device is saved locally or is otherwise obtainable by the users computing device.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method of selecting content within a web page (FIG. 1, 110; FIG. 2C, 207, FIG. 4, 407; FIG. 5, 507) comprising:
accessing first web page data associated with at least one previously accessed web page, the first web page data describing popular content within the previously accessed web page previously selected by a group of users;
accessing second web page data associated with a currently accessed web page (FIG. 1, 110; FIG. 2C, 207; FIG. 4, 407; FIG. 5, 507);
comparing the first web page data with the second web page data; and
presenting to a user, via an output device (FIG. 1, 150), equivalent web page data selected most often within the at least one previously accessed web page as selected content within the currently accessed web page (FIG. 1, 110; FIG. 2C, 207; FIG. 4, 407; FIG. 5, 507).

2. The method of claim 1, further comprising determining if the first web page data exists;
in which, if the first web page data exists, then presenting, to a user, the equivalent web page data selected most often within the at least one previously accessed web page as selected content within the currently accessed web page (FIG. 1, 110; FIG. 2C, 207; FIG. 4, 407; FIG. 5, 507), and
in which, if the first web page data does not exist, then running a default content selection algorithm to select main content within the currently accessed web page (FIG. 1, 110; FIG. 2C, 207; FIG. 4, 407; FIG. 5, 607).

3. The method of claim 2, in which, if the first web page data does not exist, and the default content selection algorithm is run, the method further comprises receiving input from a use relating to adjustments to the content selected within the currently accessed web page (FIG. 1, 110; FIG. 2C, 207; FIG. 4, 407; FIG. 5, 507).

4. The method of claim 3, further comprising saving web page data associated with content selected within the currently accessed web page (FIG. 1, 110; FIG. 2C, 207; FIG. 4, 487; FIG. 5, 507 to a data storage device.

5. The method of claim 1, further comprising receiving input from a user relating to adjustments to the content selected within the currently accessed web page (FIG. 1, 110; FIG. 2C, 207; FIG. 4, 407; FIG. 5, 507).

6. The method of claim 5, further comprising determining if changes have been made to the content selection within the currently accessed web page (FIG. 1, 110; FIG. 2C, 207; FIG. 4, 407; FIG. 5, 507);
in which, if changes have been made to the content selection the currently accessed web page (FIG. 1, 110; FIG. 2C, 207; FIG. 4, 407; FIG. 5, 507) within a predetermined threshold, then saving to a data storage device (FIG. 1, 130) new web page data describing the changes to the content selected and associated with the currently accessed web page (FIG. 1, 110; FIG. 2C, 207; FIG. 4, 407; FIG. 5, 507).

7. The method of claim 1, in which the first web page data associated with the at least one previously accessed web page is saved to a data storage device (FIG. 1, 130).

8. The method of claim 7, in which, when the first web page data is saved to a data storage device, a processor associated with the data storage device determines which content within the at least one previously selected web page is being selected most often and saves web page data associated with and describing the most often selected content within the at least one previously selected web page.

9. The method of claim 1, in which the web page data comprises at least one of a Uniform Resource Locator (URL), a web page Document Object Mo el (DOM) (FIG. 2A, 200), data defining the structure and layout of a Document Object Model (DOM) tree (FIG. 2A, 200) of a web page, layout and structure of the nodes within a Document Object Model (DOM) tree (FIG. 2A, 200), content of a web page previously selected by a user within a Document Object Model (DOM) tree (FIG. 2A, 200), content of a web page currently selected by a user within a Document Object Model (DOM) tree (FIG. 2A, 200), content of nodes previously selected by a user within a Document Object Mod& (DOM) tree (FIG. 2A, 200), content of nodes currently selected by a user within a Document Object Model (DOM) tree (FIG. 2A, 200), data relating to the amount of content of a web page which had been previously selected by a user, data relating to the amount of content of a web page which had previously not been selected by a user, data relating to the characteristics of content of a web page which had been previously selected by a user, data relating to the characteristics of content of a web page which had previously not been selected by a user, metadata associated with any of the above mentioned types of data, metadata describing any of the above mentioned types of data, data relating to when and how often a user had previously adapted a web page, data relating to when and how often a user had previously adapted content on a web page, or combinations thereof.

10. A computer program product for selecting content within a web page (FIG. 1, 110 FIG. 2C, 207; FIG. 4, 407; FIG. 5, 507), the computer program product comprising:
a computer readable storage medium having computer usable program code embodied therewith, the computer usable program code comprising:
computer usable program code that, when executed, accesses first web page data associated with at least one previously accessed web page, the first web page data describing popular content within the at least one previously accessed web page previously selected by a group of users;
computer usable program code that, when executed, accesses second web page data associated with a currently accessed web page (FIG. 1, 110; FIG. 2C, 207; FIG. 4, 407; FIG. 5, 507);
computer usable program code that, when executed, compares the first web page data with the second web page data; and
computer usable program code that, when executed, presents to a user, via an output device (FIG. 1, 150), equivalent web page data selected most often within the at least one previously accessed web page as selected content within the currently accessed web page (FIG. 110; FIG. 2C, 207; FIG. 4, 407; FIG. 6, 507).

11. The computer program product of claim 10, further comprising:
computer usable program code that, when executed, determines if the first web page data exists;
computer usable program code that, when executed, presents, to a user, equivalent web page data selected most often within the at least one previously accessed web page as selected content within the currently accessed web page (FIG. 1, 110; FIG. 2C, 207: FIG. 4, 407: FIG. 5, 507) if the first web page data exists, and
computer usable program code that, when executed, runs a default content selection to select main content within the currently accessed web page (FIG. 1, 110; FIG. 2C, 207; FIG. 4, 407; FIG. 5, 507) if the first web page data does not exist.

12. The computer program product claim 10, further comprising computer usable program code that, when executed, receives input from a user relating to adjustments to the content selected within the currently accessed web page (FIG. 1, 110; FIG. 2C, 207; FIG. 4, 407; FIG. 5, 507).

13. The computer program product of claim 12, further comprising:
computer usable program code that, when executed, determines if changes have been made to the content selection within the currently accessed web page (FIG. 1, 110; FIG. 2C, 207; FIG. 4, 407; FIG. 5, 507); and
computer usable program code that, when executed, saves new data associated with the currently accessed web page (FIG. 1, 110; FIG. 2C, 207; FIG. 4, 407; FIG. 5, 507) a data storage device (FIG. 1, 130) if changes have been made to the content selection within the currently accessed web page (FIG. 1, 110: FIG. 2C, 207; FIG. 4, 407; FIG. 5, 507) within a predetermined threshold,

14. A system for selecting content within a web page (FIG. 1, 110; FIG. 2C, 207; FIG. 4, 407; FIG. 5, 507) comprising:
a data storage device (FIG. 1, 130) that stores first we page data associated with at least one previously accessed web page and second web page data associated with a currently accessed web page (FIG. 1, 110; FIG. 2C, 207; FIG. 4, 407; FIG. 5, 507); and
a processor (FIG. 1, 125), communicatively coupled to the data storage device (FIG. 1, 130), that accesses the first and second web page data, compares the first web page data with the second web page data, and presents to a user, via an output device (FIG. 1, 150), equivalent web page data selected most often within the at least one previously accessed web page as selected content within the currently accessed web page (FIG. 1, 110; FIG. 2C, 207; FIG. 4, 407; FIG. 5, 507)
in which the first web page data describes popular content within the at least one previously accessed web page previously selected by a group of users.

15. The system of claim 10, in which the processor (FIG. 1, 125) further determines if the first web page data exists:
in which, if the first web page data exists, then the processor (FIG. 1, 125) presents, to a user, the equivalent web page data selected most often within the at least on previously accessed web page as selected content within the currently accessed web page (FIG. 1, 110; FIG. 2C, 207; FIG. 4, 407; FIG. 5, 507) and
in which, if the first web page data does not exist, then the processor (FIG. 1, 125) runs a default content selection to select main content within the currently accessed web page (FIG. 1, 110; FIG. 2C, 207; FIG. 4, 407; FIG. 5, 507).
